(19) United States
(12) Patent Application Publication
(10) Pub. No.: US 2021/0404967 A1
(43) Pub. Date: Dec. 30, 2021

(54) AN ANALYSIS CHIP

(71) Applicant: Hewlett-Packard Development Company, L.P., Spring, TX (US)

(72) Inventors: Fausto D'Apuzzo, Palo Alto, CA (US); Viktor Shkolnikov, Palo Alto, CA (US); Caitlin DeJong, Palo Alto, CA (US)

(73) Assignee: Hewlett-Packard Development Company, L.P., Spring, TX (US)

(21) Appl. No.: 17/294,054

(22) PCT Filed: Dec. 14, 2018
(86) PCT No.: PCT/US2018/065814

§ 371 Date: May 14, 2021

(51) Int. Cl. G01N 21/65

(52) U.S. Cl. CPC G01N 21/658; B82Y 15/00

(57) ABSTRACT

In one example, an analysis chip includes a substrate for surface-enhanced spectroscopy including an ordered nanostructure surface to receive a liquid including a number of analytes. The received liquid is to be guided by the ordered nanostructure surface over the substrate to separate the number of analytes.

### BACKGROUND

Sensors can be fabricated via colloid aggregation, electrochemically roughened metal surfaces, or nanoimprint lithography, among other techniques. For example, nanoimprint lithography creates patterns by mechanical deformation of imprint resist and subsequent processes. The imprint resist is typically a monomer or polymer formulation that is cured by heat or ultraviolet (UV) light during the imprinting.

Spectroscopic analysis can be performed using one or more analytes to test fabricated sensors. For example, difference in wavelengths emitted from the surfaces of sensors treated with the analytes are used to detect surface irregularities.

### BRIEF DESCRIPTION OF THE DRAWINGS

Various features of the techniques of the present application will become apparent from the following description of examples, given by way of example only, which is made with reference to the accompanying drawings, of which:

FIG. 1 is a drawing of a procedure for separating analytes using a substrate with an ordered nanostructure surface, in accordance with examples;

FIG. 2A is a drawing illustrating a square lattice pattern of Surface-Enhanced Raman Spectroscopy (SERS) clusters arranged in a circular active area of a substrate, in accordance with examples;

FIG. 2B is a drawing illustrating disjoint film propagation of a square lattice pattern of SERS clusters arranged in a substrate, in accordance with examples;

FIG. 3A is a drawing illustrating a circular pattern of SERS clusters arranged in a substrate, in accordance with examples;

FIG. 3B is a drawing illustrating a circular disjoint film propagation of an example circular pattern of SERS clusters arranged in a substrate, in accordance with examples;

FIG. 4A is a drawing illustrating a unidirectional flow pattern of SERS clusters including two different pitches, in accordance with examples;

FIG. 4B is a drawing illustrating a unidirectional flow pattern of SERS clusters including rows of nano-islands, in accordance with examples;

FIG. 4C is a drawing illustrating a unidirectional propagation along a unidirectional flow pattern of SERS clusters arranged in an arm of a substrate, in accordance with examples;

FIG. 5A is a drawing illustrating a multi-arm active area of a substrate with multiple arms having different patterns of SERS clusters, in accordance with examples;

FIG. 5B is a drawing illustrating a multi-arm propagation of a liquid with multiple analytes along a multi-arm active area of a substrate, in accordance with examples;

FIG. 6A is a drawing illustrating an interactive active area on a substrate, in accordance with examples;

FIG. 6B is a drawing illustrating an interactive propagation along an interactive active area of a substrate, in accordance with examples;

FIG. 7 is a schematic diagram illustrating an example method for dispensing liquid containing analytes onto an active area using an inkjet printer;

FIG. 8 is a schematic diagram illustrating an example method for partially soaking an active are of a substrate in a liquid containing analytes;

FIG. 9 is a schematic diagram illustrating an example method for dispensing liquid containing analytes onto an active area using an integrated microfluidic channel;

FIG. 10 is a process flow diagram illustrating an example method for separating analytes using a substrate with an ordered nanostructure surface;

FIG. 11 is a block diagram of a computing device to separate analytes and perform analysis of spectral content, in accordance with examples; and

FIG. 12 is a block diagram of a system to separate analytes and perform analysis of spectral content, in accordance with examples.

### DETAILED DESCRIPTION

Spectroscopic analysis can be performed using one or more analytes to test fabricated sensors, among various other purposes. Spectroscopic analysis can include having a sample be split into component analytes so that a clean spectra of the analyte can be detected and analyte identified. For example, this splitting can be performed using a separate chromatography step or other separation methodologies. However, performing separate methods in order to split component analytes is inefficient. Moreover, it may be difficult if not impossible to automate such methodologies.

Described herein are techniques for separating analytes using substrates for surface-enhanced spectroscopy having ordered nanostructure surfaces. As used herein an analyte refers to any substance suitable for spectroscopic analysis of analysis chips. In some examples, the analyte is a molecule, or mixture of molecules. For example, an analysis chip includes a substrate for surface-enhanced spectroscopy including an ordered nanostructure surface to receive a liquid including a number of analytes. The received liquid can be guided by the ordered nanostructure surface over the substrate to separate the number of analytes. Thus, the techniques described herein enable simultaneous sample preparation and spectroscopic analysis on a single platform. Moreover, the techniques described herein enable chemical identification of different components in complex mixtures. In various examples, the techniques described herein are used to combine thin layer chromatography (TLC) separation power with the highly sensitive chemical identification of Surface-Enhanced Spectroscopy (SES). In some examples, the techniques described herein combine TLC and SES on an inprintable ordered nano-structure substrate.

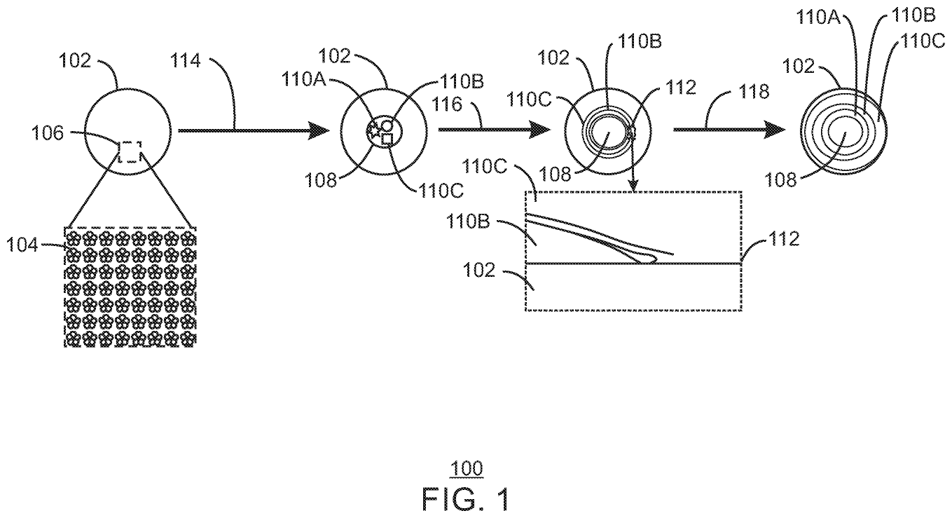

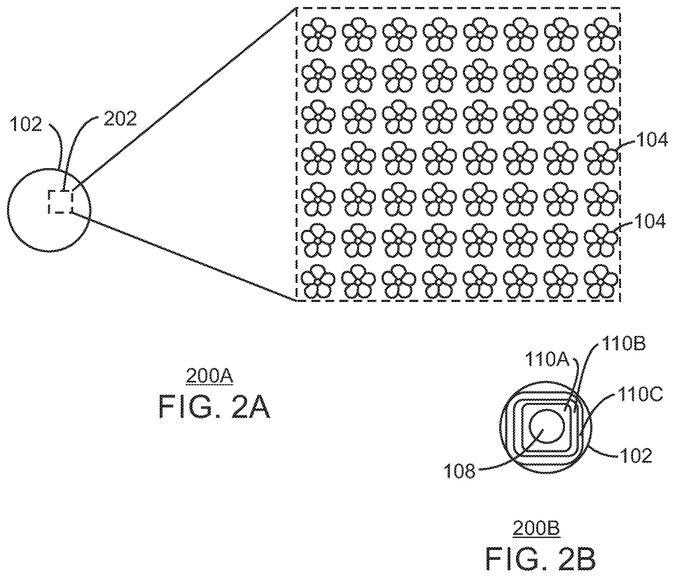

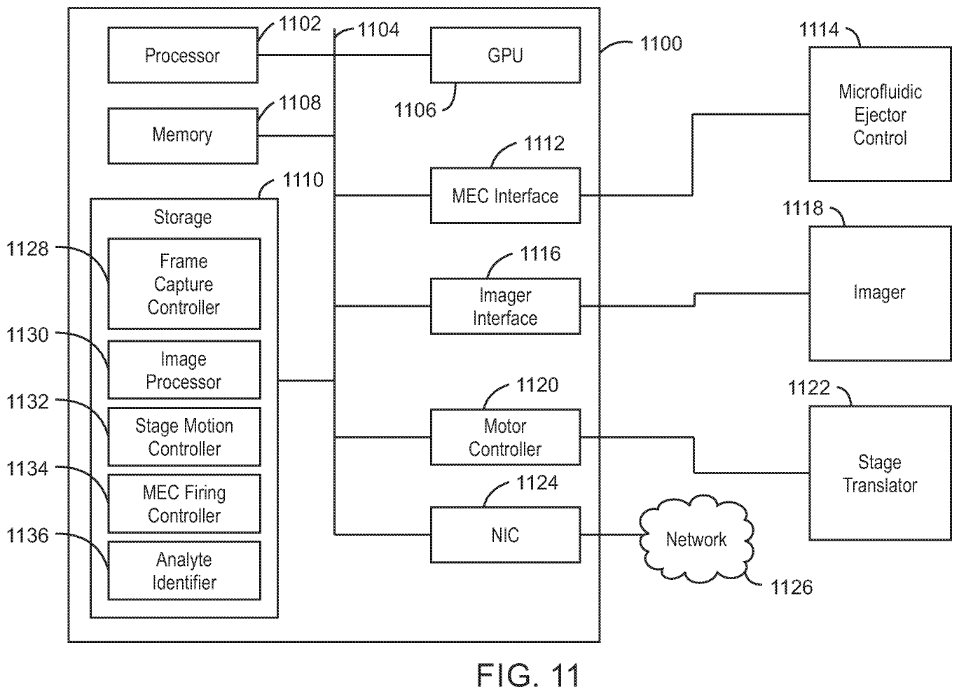

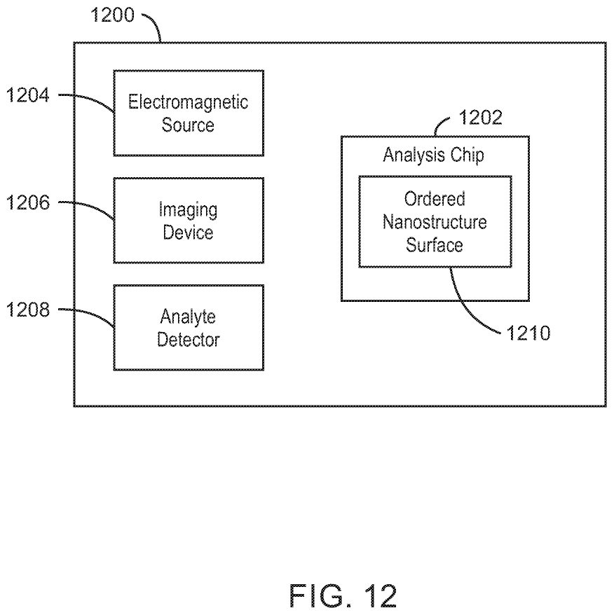

FIG. 1 is a drawing of a procedure for separating analytes using a substrate with an ordered nanostructure surface, in accordance with examples. The procedure 100 can be performed using any of the example active areas and patterns of FIGS. 2A, 3A, 4A, 4B, 4C, 5A, 6A, via the computing device 1100 of FIG. 11 or the system 1200 of FIG. 12.

FIG. 1 includes an active area 102 of a substrate that includes a number of pentamer clusters 104 as shown in magnified portion 106 of the active area 102. It can be noted that not every cluster will be formed as a pentameric, as the formation process may randomly form some amount of tetrameric or trimeric clusters, among others. As used herein, an active area refers to an area of a substrate reserved for performing the techniques described herein. For example, the active area 102 includes an ordered nanostructure surface having an ordered pattern of nanostructures. FIG. 1 further includes a liquid 108 including a number of analytes 110A, 110B, and 110C. A second magnification 112 shows a separation of analytes 110B and 110C along the active area 102.

In the method 100 a substrate is manufactured with an active area 102 having a pattern of pentamer clusters 104. In some examples, the nanopillars have metal caps (not shown) that provide a plasmon resonance that interacts with the analyte species to enhance the spectroscopic response of the analyte species, as discussed with regard to FIG. 11. For example, the nanopillars are polymer shafts with metal caps. In some examples, the collapsible nanopillars are formed from a column layer on the surface of the substrate by any number processes, including nano-embossing, lithography followed by reactive ion etching or chemical etching, and the like. In various examples, the column layer is a polymeric material that can be formed into columns by any number of processes. Polymeric materials that can be used include but are not limited to, photo resists, hard mold resins such as PMMA, soft mold polymers such as PDMS, ETFE or PTFE, or hybrid-mold cross-linked, UV-curable or thermal-curable, polymers based on acrylate, methacrylate, vinyl, epoxy, siloxane, peroxide, urethane or isocyanate. In some examples, the polymer materials are modified to improve imprint and mechanical properties with copolymers, additives, fillers, modifiers, photoinitiators, and the like. In various examples, any of the materials mentioned with respect to the substrate are used. In some examples, the substrate forms a column layer, while in other examples, the collapsible nanopillars are directly formed on the substrate.

The collapse of flexible nanopillars to form the clusters, such as the pentamer clusters, can be induced by microcapillary forces from an evaporating liquid. In some examples, a strong enhancement in surface-enhanced luminance is obtained from the nanopillars when they are collapsed into groups, referred to herein as clusters. For example, the enhancement is based on intense local electric fields generated by the plasmon resonance of adjacent metal caps at the top of the collapsed nanopillars. In some examples, the collapsed nanopillars are separated by a narrow gap on the nanometer (nm) scale.

The nanopillars are supported by an underlying substrate. In various examples, the substrate is made from silicon, glass, quartz, silicon nitride, sapphire, aluminum oxide, diamond, diamond-like carbon, or other rigid inorganic materials, such as metals and metallic alloys. In some examples, the substrate is a polymeric material, such as a polyacrylate, a polyamide, a polyolefin, such as polyethylene, polypropylene, or a cyclic olefin, a polycarbonate, polyesters such as polyethylene terephthalate, polyethylene napthalate, or other polymeric material suitable for making films. Any of these polymeric materials can be a copolymer, a homopolymer, or combination thereof. In some examples, the substrate is a web used in a roll-to-roll fabrication process. The substrate together with the nanopillars or any other suitable surface enhancement is referred to herein as a surface-enhanced substrate. In some examples, the surface-enhanced substrate is a plasmonic sensing substrate capable of supported nano-pillars or nano-islands, including nanofabricated substrates or any other plasmonic enhancement platform. As used herein, a nano-island refers to solid grouping of nanoparticles, such as a column or row of a polymeric material. As one example, the surface-enhanced substrate is a Surface-Enhanced Raman Spectroscopy (SERS) surface, a surface-enhanced infrared absorption (SEIRA) surface, or a Surface-Enhanced Luminescence (SEL).

In some examples, portions of the substrate are functionalized in a variety of different manners. For example, the surface of the substrate is coated with antibodies to make the substrate receptive to particular analytes. In various examples, such surface functionalization is performed using thiolated oligonucleotides. In some examples, thiolated fluoropolymers are used to make some regions of the surface of the substrate hydrophobic and thereby increase resistance for the meniscus to jump and retard flow in that direction.

A liquid 108 containing a number of analytes 110A, 110B, 110C is dispensed onto a portion of the active area 102 as indicated by arrow 114. For example, the liquid 108 is dispensed onto a central portion of the active area. The analytes are a type of molecule that has affinity with metallic substrates. In one example, one of the analytes is composed of trans-1,2-bis(4-pyridyl)-ethylene (BPE) molecules used with a gold substrate.

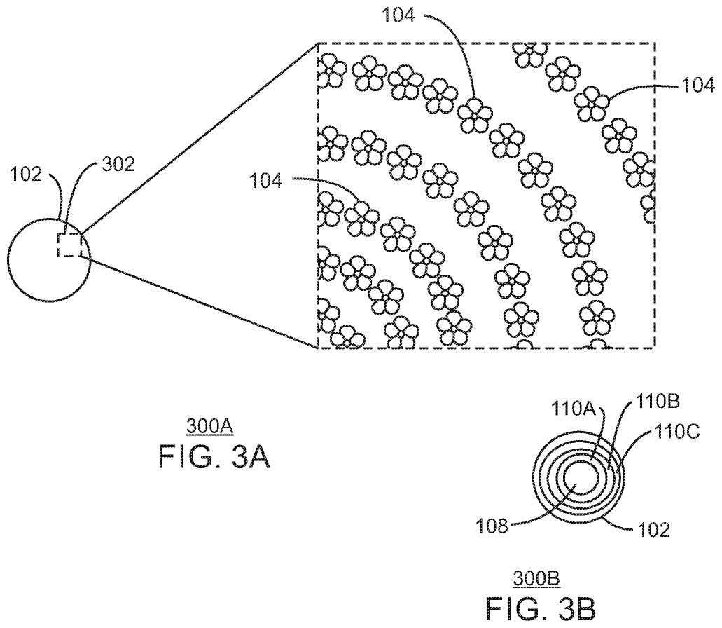

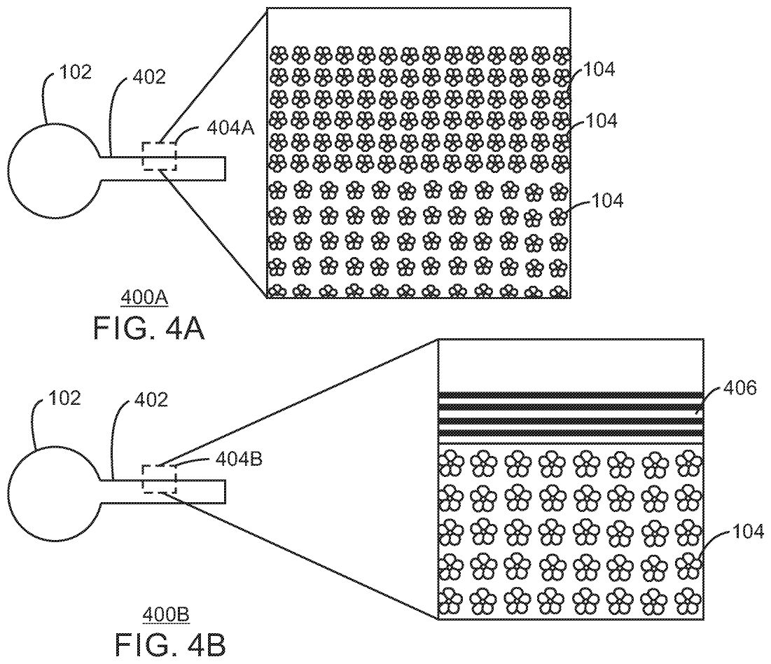

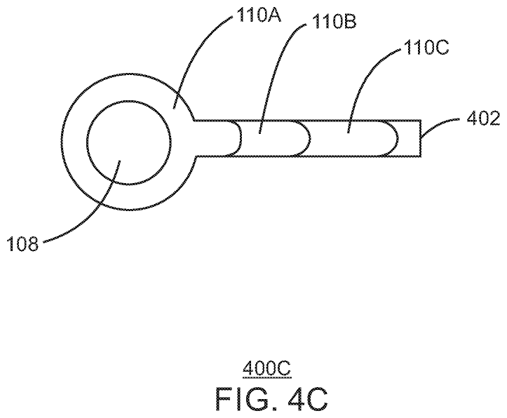

As shown by another arrow 116, after some time, the liquid 108 is spread out in different directions on the active area 102 flowing by various forces including capillary action and disjoining force. Capillary action is a force resulting from intermolecular forces between a liquid and surrounding solid surfaces. The amount of disjoining force is a disjoining pressure arising from an attractive interaction between two surfaces times the surface area of the interacting surfaces. In some examples, the flow of the liquid 108 is guided by a particular pattern of pentamer clusters 104. For example, the particular pattern can be a polygonal pattern, such as the square lattice pattern of FIG. 2A. In some examples, the particular pattern is a unidirectional flow pattern, such as the unidirectional flow pattern described in FIGS. 4A-4C. In various examples, the particular pattern is a circular pattern, as described in FIGS. 3A and 3B. The flow of the analytes in the liquid 108 can be characterized by discrete jumps between the pentamer clusters 104. For example, the analytes are attracted to the pentamer clusters 104 and can thus jump from one pentamer cluster 104 to another pentamer cluster 104 as the liquid 108 flows along between the pentamer clusters 104. As the analytes 110A, 110B, and 110C in the liquid 108 are attracted to various nanostructures via differing capillary action, the analytes 110A, 110B, and 110C separate after a first period of time indicated by arrow 116. As shown in magnification 112, the analyte 110B binds to the substrate surface under the analyte 110C, which expands to a larger ring on the active area 102 of the substrate. The dispensing of the liquid 108 onto the active area 102 thus produces a thin film, which propagates on the active area 102 and produces a differential solute diffusion of analytes 110A, 110B, and 110C.

After a predetermined period of time, as indicated by arrow 118, the analytes 110A, 110B, and 110C form concentric circles around the initial deposit of liquid 108. The separated analytes 110A, 110B, and 110C can then be probed and analyzed as discussed with respect to FIG. 11. For example, an electromagnetic source is used to probe each of the analytes 110A, 110B, and 110C and an analyte detector identify analytes based on detected spectral content from the probed analytes 110A, 110B, and 110C. In some examples, hyperspectral line-scanning or imaging is performed to capture the different vibrational fingerprints of the separated analytes 110A, 110B, and 110C.

The block diagram of FIG. 1 is not intended to indicate that the example method 100 is to include all of the components shown in FIG. 1. Further, the method 100 can include any number of additional components not shown in FIG. 1, depending on the details of the specific implementation. For example, the method 100 can include the use of other types of patterns of clusters. In some examples, the patterns include polygonal patterns, and patterns with directional flow. The method 100 can also include the use of clusters of clusters in addition to or in place of pentamer clusters. For example, the clusters are dimers, trimers, or other arrangements or combinations of nano-pillars or nano-islands as discussed herein. In some examples, the active area is formed in different shapes, and include arms, or is an interactive active area having an interactive geometry with multiple regions in which liquid is dispensed.

FIG. 2A is a drawing illustrating an example square lattice pattern of SERS clusters arranged in a circular active area of a substrate, in accordance with examples. The example square lattice pattern 200A can be used in the methods 100, 700-1000 using the computing device 1100 of FIG. 11 or the system 1200 of FIG. 12.

As shown in FIG. 2A, the square lattice pattern 200A includes a number of pentamer clusters 104. The magnification 202 of a portion of the active area 102 of a substrate shows that the pentamer clusters are arranged in an ordered pattern of rows and columns.

The drawing of FIG. 2A is not intended to indicate that the example square lattice pattern 200A is to include all of the components shown in FIG. 2A. Further, the square lattice pattern 200A can include any number of additional components not shown in FIG. 2A, depending on the details of the specific implementation. For example, the pentamer clusters 104 can be dimer, trimer, or any other form of cluster of nanopillars. In some examples, the shape of the active area 102 is replaced with other shapes. In various examples, additional numbers of clusters are used.

FIG. 2B is a drawing of a disjoint film propagation of a square lattice pattern of SERS clusters arranged in a substrate, in accordance with examples. The example disjoint film propagation 200B can be used in the methods 100, 700-1000 using the computing device 1100 of FIG. 11 or the system 1200 of FIG. 12.

As shown in FIG. 2B, a liquid 108 deposited onto a center of the circular shaped active area 102 results in a set of concentric patterns of separated analytes 110A, 110B, and 110C within the active area 102.

The drawing of FIG. 2B is not intended to indicate that the example disjoint film propagation 200B is to include all of the components shown in FIG. 2B. Further, the disjoint film propagation 200B can include any number of additional components not shown in FIG. 2B, depending on the details of the specific implementation. In various examples, analytes are included in the liquid. In some examples, additional shapes of active area are used.

FIG. 3A is a drawing illustrating a circular pattern of SERS clusters arranged in a substrate, in accordance with examples. The example circular pattern 300A can be used in the methods 100, 700-1000 using the computing device 1100 of FIG. 11. The example circular pattern 300A can be used in the methods 100, 700-1000 using the computing device 1100 of FIG. 11 or the system 1200 of FIG. 12.

As shown in FIG. 3A, the circular pattern 300A includes a number of pentamer clusters 104. The magnification 302 of a portion of the active area 102 of a substrate shows that the pentamer clusters are arranged in an ordered pattern of concentric rings. The concentric rings have a pitch gradient, in which a pitch between the clusters of different rings can increase or decrease as the rings get larger. As used herein, pitch refers to a distance from a center of a cluster of nanopillars to the center of another cluster of nanopillars.

The drawing of FIG. 3A is not intended to indicate that the example square lattice pattern 300A is to include all of the components shown in FIG. 3A. Further, the circular pattern 300A can include any number of additional components not shown in FIG. 3A, depending on the details of the specific implementation. For example, the pentamer clusters 104 can be dimer, trimer, or any other form of cluster of nanopillars. In some examples, the shape of the active area 102 is replaced with other shapes. In various examples, additional numbers of clusters are used.

FIG. 3B is a drawing illustrating an example circular disjoint film propagation of an example randomized pattern of SERS clusters arranged in a substrate, in accordance with examples. The example circular disjoint film propagation 300B can be implemented in the methods 100, 700-1000 using the computing device 1100 of FIG. 11.

As shown in FIG. 3B, a liquid 108 deposited onto a center of the circular shaped active area 102 results in a set of concentric square-shaped patterns of separated analytes 110A, 110B, and 110C within the active area 102.

The drawing of FIG. 3B is not intended to indicate that the example circular disjoint film propagation 300B is to include all of the components shown in FIG. 3B. Further, the circular disjoint film propagation 300B can include any number of additional components not shown in FIG. 3B, depending on the details of the specific implementation. For example, additional analytes can be included in the liquid. In various examples, additional shapes of active area are used.

FIG. 4A is a drawing of a unidirectional flow pattern of SERS clusters including two different pitches, in accordance with examples. The unidirectional flow pattern 400A can be used in the methods 100, 700-1000 using the computing device 1100 of FIG. 11 or the system 1200 of FIG. 12.

As shown in FIG. 4A, the unidirectional flow pattern 400A includes a number of pentamer clusters 104 arranged in two groups having different pitches. In particular, a group of pentamer clusters 104 near an edge of an arm 402 of a substrate has a smaller pitch than the pitch of clusters further away from the edge of the arm 402. The arm 402 is an extension of the active area 102 in a particular direction. In some examples, the arm 402 includes clusters with a different pitch or is functionalized differently than the active area 102. For example, the magnification 404A of a portion of the arm 402 of a substrate shows that the pentamer clusters are arranged in two groups of rows having different pitch. The use of groups of clusters with different pitches at the edges of the arm 402 can prevent analytes from leaving the arm 402 after a liquid is dispensed in the active area 102. Thus, the concentration of analytes bound in the arm 402 can be increased by preventing diffusion of the analytes out of the arm 402. The higher concentration of analytes improves the detection of spectral content resulting from probing analytes with electromagnetic radiation.

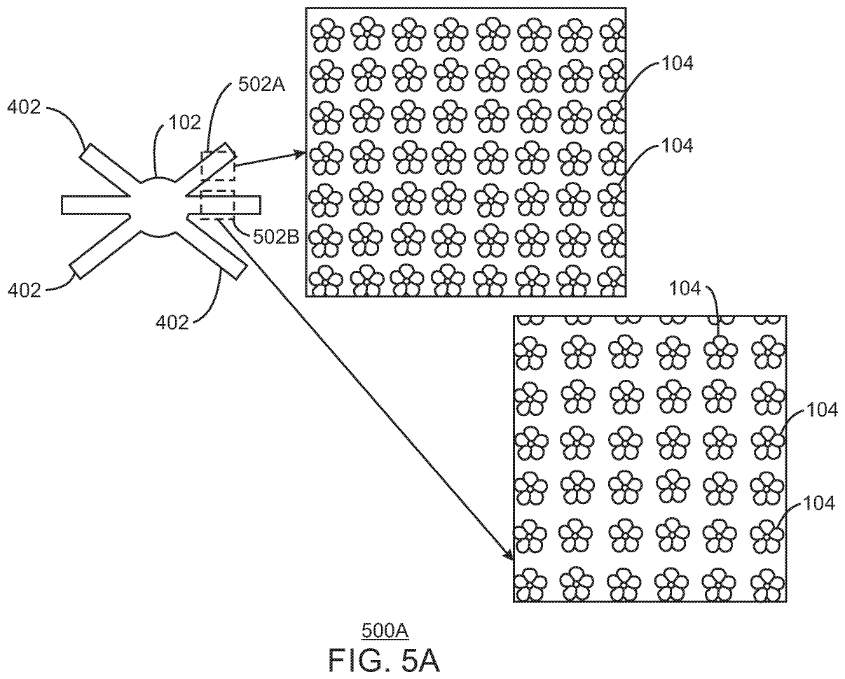

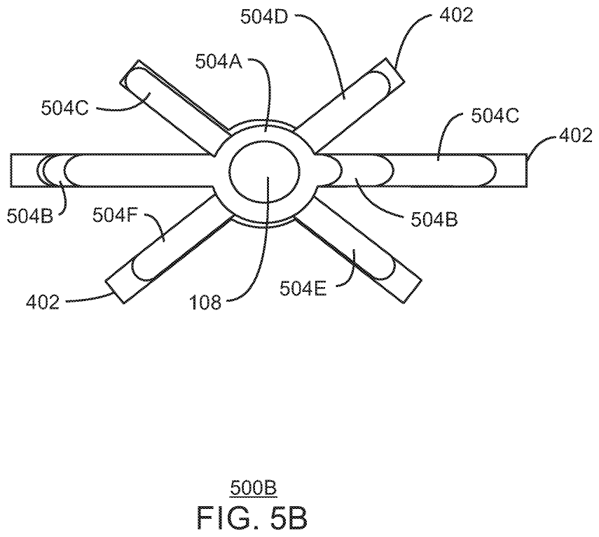

The drawing of FIG. 4A is not intended to indicate that the example unidirectional flow pattern 400A is to include all of the components shown in FIG. 4A. Further, in various examples, the unidirectional flow pattern 400A includes any number of additional components not shown in FIG. 4A, depending on the details of the specific implementation. For example, the pentamer clusters 104 can be dimer, trimer, or any other form of cluster of nanopillars. In some examples, the shape of the active area 102 is replaced with other shapes. In various examples, additional numbers of clusters or groups of clusters with different pitches, or gradients of pitches, re used. In some examples, the substrate includes additional arms 402 as discussed in FIG. 5A. In some examples, the different regions can be selectively functionalized. For example, some regions can be made hydrophobic using thiolated fluoropolymers to increase resistance for the meniscus to jump and thus slow down flow in a particular direction.

FIG. 4B is a drawing illustrating an example unidirectional flow pattern of SERS clusters including rows of nano-islands, in accordance with examples. The example square lattice pattern 400A can be used in the methods 100, 700-1000 using the computing device 1100 of FIG. 11 or the system 1200 of FIG. 12.

As shown in FIG. 4B, the unidirectional flow pattern 400B includes a number of pentamer clusters 104 arranged in a uniform pitch of rows and columns with a set of nano-islands 406 formed at the edges of the arm 402. In particular, the magnification 404B of a portion of the arm 402 of a substrate shows that the pentamer clusters are arranged in a uniform pitch below the nano-islands 406 that are arranged along the edge of the arm 402. The use of nano-islands 406 formed at the edges of the arm 402 also prevents analytes from leaving the arm 402 after a liquid is dispensed in the active area 102. The pentamer clusters 104 arranged in the unidirectional flow pattern 400B can thus create a preferential unidirectional flow for the liquid. Thus, the concentration of analytes bound in the arm 402 is increased by preventing diffusion of the analytes out of the arm 402. The higher concentration of analytes improves the detection of spectral content resulting from probing analytes with electromagnetic radiation, as discussed with respect to FIG. 11 below.

The drawing of FIG. 4B is not intended to indicate that the example unidirectional flow pattern 400B is to include all of the components shown in FIG. 4B. Further, the unidirectional flow pattern 400B can include any number of additional components not shown in FIG. 4B, depending on the details of the specific implementation. For example, the pentamer clusters 104 can be dimer, trimer, or any other form of cluster of nanopillars. In some examples, the shape of the active area 102 is replaced with other shapes. In some examples, additional numbers of clusters or groups of clusters with different pitches, or gradients of pitches, are used. In some examples, the substrate includes additional arms 402 as discussed in FIG. 5A.

FIG. 4C is a drawing illustrating an example unidirectional propagation along a unidirectional flow pattern of SERS clusters arranged in an arm of a substrate, in accordance with examples. The example unidirectional propagation 4000 can be generated using the unidirectional flow pattern 400A or 400B of FIGS. 4B and 4C and used in the methods 100, 700-1000 and implemented the computing device 1100 of FIG. 11 or the system 1200 of FIG. 12.

As shown in FIG. 4C, the unidirectional propagation 4000 includes a dispensed liquid 108 containing analytes 100A, 100B, and 100C. The liquid 108 is dispensed in the center of a circular active area and, after a predetermined amount of time, results in the analytes 100A, 100B, and 100C separating along the length of the arm 402. The analytes 100A, 100B, and 100C separate due to different interactions of the analytes 100A, 100B, and 100C with any number of microstructures such as clusters of nanopillars. In some examples, the arm 402 is functionalized to separate out the analytes 100A, 100B, and 100C. As one example, the flow of analytes 100A, 100B, and 100C is controlled by selectively functionalizing different regions. For example, some regions are made hydrophobic using thiolated fluoropolymers to increase resistance for the meniscus to jump, and thereby slow flow in such regions.

The drawing of FIG. 4C is not intended to indicate that the example unidirectional propagation 4000 is to include all of the components shown in FIG. 4C. Further, the unidirectional propagation 4000 can include any number of additional components not shown in FIG. 4C, depending on the details of the specific implementation. For example, additional analytes can be included in the liquid and additional arms can be coupled to the active area.

FIG. 5A is a drawing illustrating an example multi-arm active area of a substrate with multiple arms having different patterns of SERS clusters, in accordance with examples. The example multi-arm active area 500A can be used in the methods 100, 700-1000 using the computing device 1100 of FIG. 11.

As shown in FIG. 5A, the multi-arm active area 500A includes a number of pentamer clusters 104 arranged in multiple arms 402 coupled to an active area 102 on a substrate. The magnifications 502A and 502B of two portions of two of the arms 402 on the substrate shows that the pentamer clusters 104 are arranged in two groups having different pitch. In particular, the pitch of the pentamer clusters 104 in 502A is smaller than the pitch of the pentamer clusters 104 in 502B. The active area 102 is a common area onto which a liquid with multiple analytes is to be dispensed. The use of groups of pentamer clusters 104 with different pitches at the arms 402 enables the different analytes to propagate out to different arms 402, as discussed with respect to FIG. 5B. Thus, the multi-arm active area 500A enables predetermined locations to be probed for analysis of different analytes.

The drawing of FIG. 5A is not intended to indicate that the example multi-arm active area 500A is to include all of the components shown in FIG. 5A. Further, the multi-arm active area 500A can include any number of additional components not shown in FIG. 5A, depending on the details of the specific implementation. For example, the pentamer clusters 104 can be dimer, trimer, or any other form of cluster of nanopillars. In some examples, the shape of the active area 102 is replaced with other shapes. In various examples, additional numbers of clusters or groups of clusters with different pitches, or gradients of pitches, are used. In addition, in some examples, any number of additional arms 402 are included in the multi-arm active area 500A.

FIG. 5B is a drawing illustrating an example multi-arm propagation of a liquid with multiple analytes along a multi-arm active area of a substrate, in accordance with examples. The example multi-arm propagation 500B can be used in the methods 100, 700-1000 using the computing device 1100 of FIG. 11.

As shown in FIG. 5B, a liquid 108 deposited onto a center of the circular shaped active area 102 results in a set of separated analytes 504A, 504B, 504C, 504D, 504E, and 504F. Since the separated analytes 504A, 504B, 504C, 504D, 504E, and 504F propagate into different arms 402, in some examples, a predetermined region along each of the arms 402 is used to probe the different analytes 504A, 504B, 504C, 504D, 504E, and 504F with electromagnetic radiation and thus perform any number of assays. In various other examples, the regions are determined after the propagation of analytes 504A, 504B, 504C, 504D, 504E, and 504F using imaging.

The drawing of FIG. 5B is not intended to indicate that the example multi-arm propagation 500B is to include all of the components shown in FIG. 5B. Further, the multi-arm propagation 500B can include any number of additional components not shown in FIG. 5B, depending on the details of the specific implementation. For example, additional analytes can be included in the liquid and additional arms can be included in the multi-arm active area.

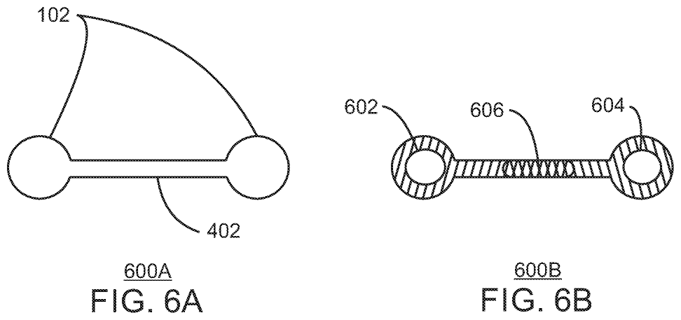

FIG. 6A is a drawing illustrating an example interactive active area on a substrate, in accordance with examples. The example interactive active area 600A can be used in the methods 100, 700-1000 using the computing device 1100 of FIG. 11.

As shown in FIG. 6A, the interactive active area 600A includes a pair of active areas 102 coupled together by an arm 402. The use of multiple active areas 102 for dispensing liquid enables different analytes to propagate out to different ends of an arm 402, as discussed with respect to FIG. 6B. Thus, the interactive active area 600A enables reagents to interact in the arm 402, to highlight the presence of certain analytes to complement spectroscopic information, as discussed in FIG. 6B.

The drawing of FIG. 6A is not intended to indicate that the example interactive active area 600A is to include all of the components shown in FIG. 6A. Further, the interactive active area 600A may include any number of additional components not shown in FIG. 6A, depending on the details of the specific implementation. For example, the interactive active area 600A may include clusters that can be dimer, trimer, pentamer, or any other form of cluster of nanopillars. In some examples, the shape of the active areas 102 is replaced with other shapes. In various examples, clusters with different pitches, or gradients of pitches, are used. In some examples, any number of additional arms 402 are included in the interactive active area 600A to any of the active areas 102 to additional active areas 102.

FIG. 6B is a drawing illustrating an example interactive propagation along an interactive active area of a substrate, in accordance with examples. The example interactive propagation 600A can be used in the methods 100, 700-1000 using the computing device 1100 of FIG. 11.

As shown in FIG. 6B, liquids 602 and 604 deposited onto a center of the circular shaped active areas 102 results in an interaction 606 between the two liquids 602 and 604 in an overlap region of the arm. For example, the liquids 602 and 604 may include different reagents that interact in the interaction 606. In some examples, a predetermined region in the arm coupling the two circular active areas is used to probe the interaction 606 with electromagnetic radiation. In some examples, the regions are determined after the propagation of the two liquids 602 and 604 using imaging.

The drawing of FIG. 6B is not intended to indicate that the example interactive propagation 600B is to include all of the components shown in FIG. 6B. Further, the interactive propagation 600B may include any number of additional components not shown in FIG. 6B, depending on the details of the specific implementation. For example, additional reagents can be included in additional active areas coupled by additional arms.

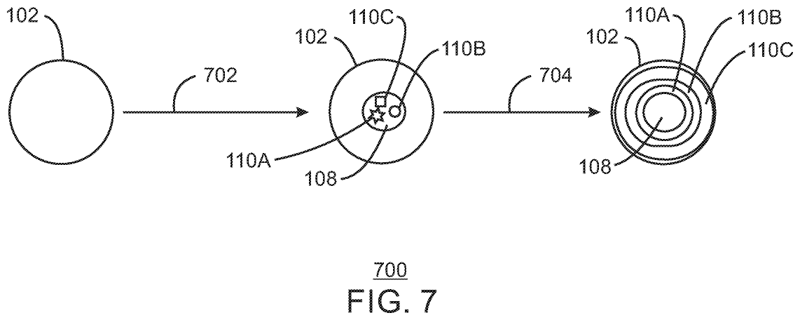

FIG. 7 is a drawing illustrating an example method for dispensing liquid containing analytes onto an active area using an inkjet printer. The method 700 can be performed by the computing device 1100 of FIG. 11 using any of the example active areas and patterns of FIGS. 2A, 3A, 4A, 4B, 4C, 5A, 6A, via the computing device 1100 of FIG. 11 and the system 1200 of FIG. 12.

The method 700 includes depositing a droplet of liquid 108 including analytes 110A, 110B, and 110C onto an active area 102, as indicated by an arrow 702. For example, the liquid 108 can be an ink deposited using an inkjet printer. In some examples, the inkjet printer is a thermal inkjet (TIJ) printer. In other examples, the inkjet printer is a piezo inkjet (PIJ) printer. As indicated by an arrow 704, after a predetermined amount of time, the analytes 110A, 110B, and 110C separate as the liquid 108 forms a film that disperses across the active area 102. The analytes 110A, 110B, and 110C can then be probed using electromagnetic radiation. In some examples, the analytes 110A, 110B, and 110C can be probed using hyperspectral line-scanning or imaging.

The drawing of FIG. 7 is not intended to indicate that the example method 700 is to include all of the components shown in FIG. 7. Further, the method 700 may include any number of additional components not shown in FIG. 7, depending on the details of the specific implementation. For example, the method 700 may include the use of other patterns of clusters resulting in different patterns of film propagation. In some examples, the patterns used include polygonal patterns, or patterns with directional flow. For example, a polygonal pattern can include a polygonal lattice, in the form of a square, or any other polygon. In various examples, the method 700 also includes the use dimer, trimer, or pentamer clusters, or other arrangements of nano-pillars or nano-islands as discussed herein. In some examples, the active area is formed in different shapes, and includes arms, or is an interactive active area having an interactive geometry with multiple regions in which liquid is dispensed as discussed in FIGS. 6A and 6B.

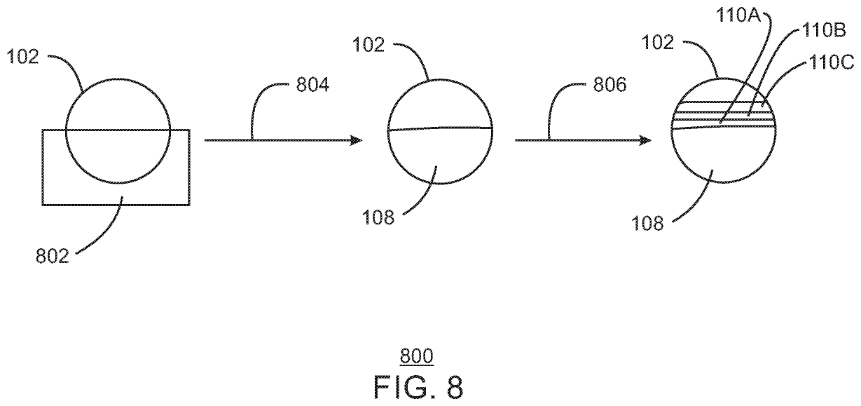

FIG. 8 is a drawing illustrating a process for partially soaking an active are of a substrate in a liquid containing analytes, in accordance with examples. The process 800 can be performed by the computing device 1100 of FIG. 11 using any of the example active areas and patterns of FIGS. 2A, 3A, 4A, 4B, 4C, 5A, 6A, via the computing device 1100 of FIG. 11 and the system 1200 of FIG. 12.

The process 800 includes soaking an active area 102 of a substrate in a reservoir 802 of liquid 108 including analytes 110A, 110B, and 110C. In some examples, half of active area 102 is submerged into the reservoir 802. As indicated by an arrow 804, the method 800 includes removing the active area 102 of the substrate out of the reservoir 802. As indicated by an arrow 806, after a predetermined amount of time, the analytes 110A, 110B, and 110C separate as the liquid 108 forms a film that propagates across the remaining portion of the active area 102. The analytes 110A, 110B, and 110C can then be probed using electromagnetic radiation. In some examples, the analytes 110A, 110B, and 110C can be probed using hyperspectral line-scanning or imaging.

The drawing of FIG. 8 is not intended to indicate that the example method 800 is to include all of the components shown in FIG. 8. Further, the method 800 can include any number of additional components not shown in FIG. 8, depending on the details of the specific implementation. For example, the method 800 can include the use of other shapes of active area 102. The method 700 can also include the use dimer, trimer, or pentamer clusters, or other arrangements of nano-pillars or nano-islands as discussed herein. In some examples, the active area includes arms, or is an interactive active area having an interactive geometry with multiple regions in which liquid is dispensed as discussed in FIGS. 6A and 6B.

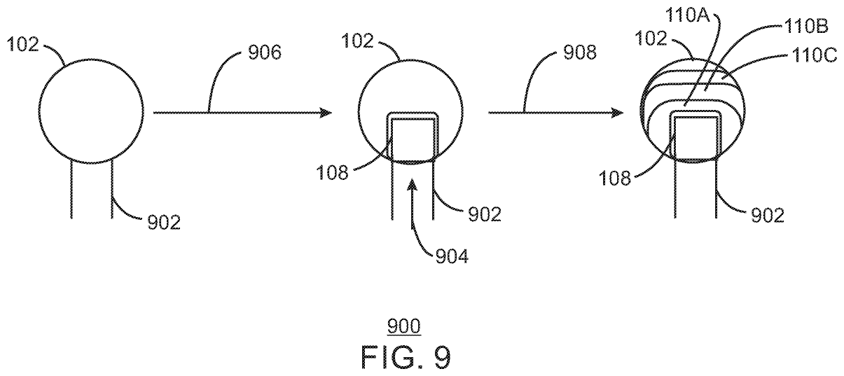

FIG. 9 is a drawing illustrating a process for dispensing liquid containing analytes onto an active area using an integrated microfluidic channel, in accordance with examples. The method 900 can be performed by the computing device 1100 of FIG. 11 using any of the example active areas and patterns of FIGS. 2A, 3A, 4A, 4B, 4C, 5A, 6A, via the computing device 1100 of FIG. 11 and the system 1200 of FIG. 12.

The process 900 includes forming an active area 102 with a coupled microchannel 902. Thus, the microchannel 902 can be integrated into a substrate having the active area 102. As indicated by an arrows 904 and 906, the process 900 includes depositing a liquid 108 including analytes 110A, 110B, and 110C onto an active area 102. For example, the liquid 108 can includes analytes 110A, 110B, and 110C. As indicated by an arrow 908, after a predetermined amount of time, the analytes 110A, 110B, and 110C separate as the liquid 108 forms a film that disperses across the active area 102. The analytes 110A, 110B, and 110C can then be probed using electromagnetic radiation. In some examples, the analytes 110A, 110B, and 110C can be probed using hyperspectral line-scanning or imaging.

The drawing of FIG. 9 is not intended to indicate that the example process 900 is to include all of the components shown in FIG. 9. Further, the process 900 can include any number of additional components not shown in FIG. 9, depending on the details of the specific implementation. For example, the process 900 can include the use of other shapes of active area 102. The process 900 can also include the use dimer, trimer, or pentamer clusters, or other arrangements of nano-pillars or nano-islands as discussed herein. In some examples, the active area can also include arms, or is an interactive active area having an interactive geometry with multiple regions in which liquid is dispensed as discussed in FIGS. 6A and 6B.

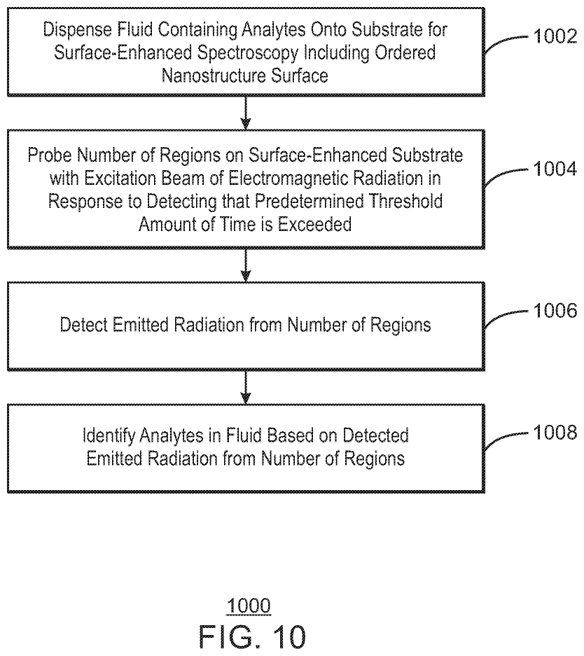

FIG. 10 is a process flow diagram illustrating a method for separating analytes using a substrate with an ordered nanostructure surface, in accordance with examples. The method 1000 of FIG. 10 can be implemented using any of the active areas and patterns of FIGS. 2A, 3A, 4A, 4B, 4C, 5A, 6A, and in the computing device 1100 or the system 1200 of FIGS. 11 and 12. For example, the method can be implemented using processor 1102 of the computing device 1100 of FIG. 11.

At block 1002, a liquid containing analytes is dispensed onto a substrate for surface-enhanced spectroscopy including an ordered nanostructure surface. For example, the liquid can be printed onto the ordered nanostructure surface via an inkjet printer. In some examples, the liquid is dispensed onto the ordered nanostructure surface via a microfluidic channel integrated into the substrate. In some examples, the substrate is partially soaked in the liquid. In some examples, the ordered nanostructure surface includes an active area onto which the liquid is dispensed. For example, the active area can be a circle or any other shape. In various examples, the active area is coupled to an arm. In some examples, multiple active areas are coupled to the same arm to form an interactive active area.

At block 1004, a number of regions on the substrate are probed with an excitation beam of electromagnetic radiation in response to detecting that a predetermined threshold amount of time is exceeded. For example, the regions can be illuminated using a laser beam.

At block 1006, the emitted radiation is detected from the number of regions. For example, the emitted radiation can be detected via a sensor of an imager. In some examples, the emitted radiation can be detected using hyperspectral imaging. For example, hyperspectral imaging can include infrared (IR) imaging, Raman raster-scanning, or line-scan mapping.

At block 1008, the analytes in the liquid are identified based on detected emitted radiation from one of the number of regions. For example, the detected emitted radiation is matched with an analyte in a list of analytes with corresponding emitted radiation. In some examples, the analytes are identified using surface-enhanced Raman spectroscopic (SERS) techniques.

It is to be understood that the process flow diagram of FIG. 10 is not intended to indicate that all of the elements of the method 1000 are to be included in every case. Further, any number of additional elements not shown in FIG. 10 can be included in the method 1000, depending on the details of the specific implementation.

FIG. 11 is a block diagram of a computing device 1100 to generate calibration curves and perform analysis of spectral content, in accordance with examples. The computing device 1100 includes a central processing unit (CPU) 1102 that executes stored instructions. In various examples, the CPU 1102 is a microprocessor, a system on a chip (SoC), a single core processor, a dual core processor, a multicore processor, a number of independent processors, a computing cluster, and the like.

The CPU 1102 is communicatively coupled to other devices in the computing device 1100 through a bus 1104. The bus 1104 can include a peripheral component interconnect (PCI) bus, and industry standard architecture (EISA) bus, a PCI express (PCIe) bus, high-performance interconnects, or a proprietary bus, such as used on a system on a chip (SoC).

The bus 1104 can couple the CPU 1102 to a graphics processing unit (GPU) 1106, such as units available from Nvidia, Intel, AMD, ATI, and others. If present, the GPU 1106 provides graphical processing capabilities to enable the high-speed processing of images from the camera. The GPU 1106 is configured to perform any number of graphics operations. For example, the GPU 1106 can be configured to pre-process the number of image frames by isolating regions on which to print microdots, downscaling, reducing noise, correcting lighting, and the like. In examples that use only spectroscopic techniques, the GPU 1106 may not be present.

A memory device 1108 and a storage device 1110 is coupled to the CPU 1102 through the bus 1104. In some examples, the memory device 1108 and the storage device 1110 are a single unit, e.g., with a contiguous address space accessible by the CPU 1102. The memory device 1108 holds operational code, data, settings, and other information used by the CPU 1102 for the control. In various embodiments, the memory device 1108 includes random access memory (RAM), such as static RAM (SRAM), dynamic RAM (DRAM), zero capacitor RAM, embedded DRAM (eDRAM), extended data out RAM (EDO RAM), double data rate RAM (DDR RAM), resistive RAM (RRAM), and parameter RAM (PRAM), among others.

The storage device 1110 is used to hold longer-term data, such as stored programs, an operating system, and other code blocks used to implement the functionality of the system. In various examples, the storage device 1110 includes non-volatile storage devices, such as a solid-state drive, a hard drive, a tape drive, an optical drive, a flash drive, an array of drives, or any combinations thereof. In some examples, the storage device 1110 includes non-volatile memory, such as non-volatile RAM (NVRAM), battery backed up DRAM, flash memory, and the like. In some examples, the storage device 1110 includes read only memory (ROM), such as mask ROM, programmable ROM (PROM), erasable programmable ROM (EPROM), and electrically erasable programmable ROM (EEPROM).

A number of interface devices are coupled to the CPU 1102 through the bus 1104. In various examples, the interface devices include a microfluidic ejector controller (MEC) interface 1112, an imager interface 1116, and a motor controller 1120, among others.

The MEC interface 1112 couples the computing device 1100 to a microfluidic ejector controller 1114. The MEC interface 1112 directs the microfluidic ejector controller 1114 to fire microfluidic ejectors in a microfluidic ejector array, either individually or as a group. As described herein, the firing is performed to form of cluster patterns on an active area of collapsible nanopillars. In some examples, the firing is also performed to dispense ink containing analytes onto an active area already included cluster patterns.

The imager interface 1116 couples the computing device 1100 to an imager 1118. The imager interface 1116 is a high-speed serial or parallel interface, such as a PCIe interface, a Universal Serial Bus (USB) 3.0 interface, a FireWire interface, and the like. In various examples, the imager 1118 is a high frame-rate camera configured to transfer data and receive control signals over the high-speed interface. In some examples, the imager 1118 is a multichannel spectroscopic system, or other optical device.

The motor controller 1120 couples the computing device 1100 to a stage translator 1122. In some examples, the motor controller 1120 is a stepper motor controller or a servo motor controller, among others. The stage translator 1122 includes a motor, a sensor, or both, coupled to the motor controller 1120 to move the stage and attached print medium or collection vessels, under a microfluidic ejector.

A network interface controller (NIC) 1124 is used to couple the computing device 1100 to a network 1126. In various examples, this allows for the transfer of control information to the computing device 1100 and data from the computing device 1100 to units on the network 1126. The network 1126 can be a wide area network (WAN), a local area network (LAN), or the Internet, among others. In some examples, the NIC 1124 connects the computing device 1100 to a cluster computing network, or other high-speed processing system, where image processing and data storage occur. A cluster computing network can used by computing devices 1100 that do not include a GPU 1106 for graphical processing. In some examples, a dedicated human machine interface (HMI) (not shown) is included in the computing device 1100 for local control of the systems. In various examples, the HMI includes a display and keyboard.

The storage device 1110 can include code blocks used to implement the functionality of the system. In various examples, the code blocks include a capture controller 1128 that is used to capture images from the imager 1118. For example, the images can depict surface-enhanced substrates having a thin film of separated analytes. In some examples, a GPU 1106 is used to identify a region including a separated analyte on a surface-enhanced substrate and process the region to identify the particular analyte located in the region. In some examples, predetermined regions are captured in high magnification.

An image processor 1130 processes captured images to detect spectral content. In various examples, the spectral content includes an intensity level of a particular portion of the spectrum from one of more of the analytes.

A stage motion controller 1132 directs the motor controller 1120 to move the stage translator 1122. In some examples, the motor controller 1120 is used to move a deposit medium, such as an analysis chip including a surface-enhanced substrate, under a microfluidic ejector array. In other examples, the motor controller 1120 is used to move an analysis chip including a dispensed liquid into a light source or electromagnetic source for imaging by the imager 1118.

An MEC firing controller 1134 uses the MEC interface 1112 to direct a microfluidic ejector controller 1114 to fire a microfluidic ejector. In some examples, the firing is performed to deposit a microdot of liquid onto a surface-enhanced substrate of an analysis chip for forming cluster patterns of collapsed nanopillars. In other examples, firing is performed to deposit liquid onto an active area of a surface-enhanced substrate of an analysis chip for analyte identification.

An analyte identifier 1136 uses images from the image 1118 to extract spectral content associated with an analyte and identify the analyte based on the extracted spectral content. In some examples, the analyte identifier 1136 uses Raman spectroscopic techniques to identify the analyte.

FIG. 12 is a block diagram of a system to separate analytes and perform analysis of spectral content, in accordance with examples. The system 1200 can be implemented using the methods 100, and 700-1000 via the computing device 1100.

The system 1200 includes an analysis chip 1202, an electromagnetic source 1204, an imaging device 1206, and an analyte detector 1208. The analysis chip 1202 further includes an ordered nanostructure surface 1210.

In the system 1200, the analysis chip 1202 can include a substrate manufactured with an ordered nanostructure surface 1210. For example, the ordered nanostructure surface 1210 can include a substrate with a number of nanopillars or nano-islands formed into a pattern. In some examples, the pattern is a dimer, trimer, or pentamer cluster pattern of nanopillars. In some examples, the nanopillars are collapsible. For example, the pattern of nanopillars can be formed by printing a pattern of ink onto the collapsible nanopillars to cause the nanopillars to collapse and form a pattern. In some examples, the ordered nanostructure surface 1210 can be functionalized using any number of coatings. For example, the coating can include antibodies that make portions of the substrate receptive to particular analytes.

The electromagnetic source 1204 can probe a number of regions on the substrate with an excitation beam of electromagnetic radiation in response to detecting that a predetermined threshold amount of time is exceeded. For example, the regions can be illuminated using a laser beam.

The imaging device 1206 can detect emitted radiation from the number of regions. For example, the emitted radiation can be detected via a sensor of an imager. In some examples, the emitted radiation can be detected using hyperspectral line-scanning or imaging.

The analyte detector 1208 can detect an analyte in the liquid based on the detected emitted radiation from one of the number of regions. For example, the analyte can be detected based on a shift in emitted radiation from radiation applied by an electromagnetic source.

Although shown as contiguous blocks, the logic components can be stored in any order or configuration. For example, if the storage is a hard drive, the logic components can be stored in non-contiguous, or even overlapping, sectors.

While the present techniques may be susceptible to various modifications and alternative forms, the examples discussed above have been shown only by way of example. It is to be understood that the technique is not intended to be limited to the particular examples disclosed herein. Indeed, the present techniques include all alternatives, modifications, and equivalents falling within scope of the appended claims.

What is claimed is:

1. An analysis chip, comprising:
a substrate for surface-enhanced spectroscopy comprising an ordered nanostructure surface to receive a liquid comprising a plurality of analytes, the received liquid to be guided by the ordered nanostructure surface over the substrate to separate the plurality of analytes.

2. The analysis chip of claim 1, wherein the ordered nanostructure surface comprises collapsible nanopillars collapsed into sets of clusters.

3. The analysis chip of claim 1, wherein the ordered nanostructure surface comprises a polygonal lattice.

4. The analysis chip of claim 1, wherein the ordered nanostructure surface is configured to create a preferential unidirectional flow for the liquid.

5. The analysis chip of claim 1, wherein the ordered nanostructure surface is configured with a plurality of arms coupled to a common area onto which the liquid is to be dispensed, wherein each of the plurality of arms comprises a different lattice spacing, material coating, or surface functionalization.

6. The analysis chip of claim 1, wherein the ordered nanostructure surface comprises a plurality of regions to receive reagents that are to interact in an overlap region of the ordered nanostructure surface coupled to the plurality of regions.

7. The analysis chip of claim 1, wherein the ordered nanostructure surface comprises a pitch gradient.

8. The analysis chip of claim 1, wherein the ordered nanostructure surface comprises a plurality of dimer, trimer, or pentamer clusters, or any combination thereof.

9. The analysis chip of claim 1, wherein the ordered nanostructure surface comprises a combination of nano-pillars and nano-islands.

10. A method comprising:
dispensing a liquid containing a plurality of analytes onto a substrate for surface-enhanced spectroscopy comprising an ordered nanostructure surface;
probing a plurality of regions on the substrate with an excitation beam of electromagnetic radiation in response to detecting that a predetermined threshold amount of time is exceeded;
detecting emitted radiation from the plurality of regions; and
identifying an analyte of the plurality of analytes in the liquid based on detected emitted radiation from one of the plurality of regions.

11. The method of claim 10, wherein dispensing the liquid comprises printing the liquid onto the ordered nanostructure surface via an inkjet printer.

12. The method of claim 10, wherein dispensing the liquid comprises dispensing the liquid onto the ordered nanostructure surface via a microfluidic channel integrated into the substrate.

13. The method of claim 10, wherein dispensing the liquid comprises partially soaking the substrate in the liquid.

14. The method of claim 10, wherein detecting the emitted radiation from the plurality of regions comprises performing hyperspectral line-scanning or imaging on the plurality of regions.

15. A system, comprising:
an analysis chip comprising substrate for surface-enhanced spectroscopy having an ordered nanostructure surface configured to guide a liquid dispensed thereon, wherein the liquid comprises a plurality of analytes to be separated by the ordered nanostructure surface;
an electromagnetic source to probe a plurality of regions on the substrate with an excitation beam of electromagnetic radiation in response to detecting that a predetermined threshold amount of time is exceeded;
an imaging device to detect emitted radiation from the plurality of regions; and
an analyte detector to detect an analyte in the liquid based on the detected emitted radiation from one of the plurality of regions.
